(19) United States
(12) Patent Application Publication
(10) Pub. No.: US 2003/0127437 A1
(43) Pub. Date: Jul. 10, 2003

(54) System and method for laser machining of extended length workpieces

(75) Inventor: Jeff McLaughlin, Richmond, TX (US)

Correspondence Address: Alan R. Thiele, JENKENS & GILCHRIST, P.C., Suite 3200, 1445 Ross Avenue, Dallas, TX, 75202-2799, US

(73) Assignee: S & S Trust

(21) Appl. No.: 10/337,025

(22) Filed: Jan. 6, 2003

Related U.S. Application Data
(60) Provisional application No. 60/344,992, filed on Jan. 4, 2002.

(51) Int. Cl. B23K 26/38; B23K 26/08

(52) U.S. Cl. 219/121.67; 219/121.7; 219/121.71; 219/121.72

(57) ABSTRACT

A system for forming cut lines or holes in an extended length workpiece includes an accurately positionable work table assembly and a laser machining system. By accurately controlling the movement of the work table assembly with respect to the laser machining system, an array of cut lines or holes can be formed in multiple planes of the extended length workpiece.

This patent application claims the benefit of U.S. Provisional Patent Application 60/344,992, filed Jan. 4, 2002.

### FIELD

The present invention relates to a system and method for forming cut lines or holes in an extended length workpiece using laser machining techniques.

### BACKGROUND

The use of laser machining techniques to form cut lines or holes in workpieces has become a well accepted part of modem manufacturing practices. Most systems using laser machining techniques are adapted for utilization with large planar workpieces. Specifically, a planar workpiece, such as a large metal plate, is placed on a stationary worktable or a conveyor. The large planar workpiece is then positioned manually or moved by a conveyor so that it is located under a laser cutting system. Based on the position of the large planar workpiece, the laser cutting system is then moved over the large planar workpiece into a variety of positions where cut lines can be made or holes formed. The accuracy of the cut line location or the accuracy of the hole placement is primarily dependent on the accuracy of the movement of the laser with respect to the planar workpiece.

As laser machining techniques have improved since their initial introduction into fabrication on large metal workpieces, laser machining techniques have been adapted for use with larger and larger plates. Thus, an elaborate and complicated laser positioning system is typically combined with a robust support system to position the laser beam light generator at the desired position with respect to the planar workpiece.

One such system is shown in U.S. Pat. No. 5,338,914 to Omote which teaches the use of a chain driven conveyor for positioning planar workpieces under a thermal cutting system. As the workpiece moves in one direction, the thermal cutting device moves in a perpendicular direction to cut the planar workpiece into smaller pieces.

Another such laser machining system, described in U.S. Pat. No. 5,132,510 to Klingel et al., teaches the use of a laser for cutting or welding a planar workpiece. A movement mechanism is provided to pass the planar workpiece under the laser. Once under the laser, a two axis positioning system is then used to cause the laser beam generator to move with respect to the planar workpiece.

Yet a third such laser machining system is described in U.S. Pat. No. 5,128,512 to Seki where a planar workpiece is placed on a setting plate. The setting plate is then placed on a plurality of driven rollers. The planar workpiece and setting plate are then moved as a single unit under the laser machining system by rotation of the driven rollers until the setting plate contacts a fixed stop.

According to the foregoing prior art, the greater the travel of the laser, the greater the need to support the laser beam light generator. This increased need for support is because the weight of the laser beam light generator will cause deflection in its support system. Such deflection in the support system affects the accuracy of the location of the cut line or the position of the hole in the workpiece. Accordingly, when hole or cut line location or size tolerances are very small, in the order of ±0.005″, such tolerances cannot be maintained on large workpieces because of deflections in the laser light generator support system.

Heretofore, it was thought to be impossible to use laser machining techniques with extended length workpieces such as a frame rail for a truck. This impossibility grew out of the conventional thinking among those manufacturers selling laser machining systems that tight tolerances could not be maintained when the length of the workpiece exceeded about 14 ft. Accordingly, many manufacturers of frame rails for trucks continued using the prior art technique of punching holes at desired locations in the frame rail and then heat-treating the frame rail with the holes punched therein to achieve the desired metallurgical properties. It was well known, however, that if a system and method could be devised for using laser machining techniques for extended length workpieces such as frame rails, the follow-on step of heat treating the frame rail after forming the holes could be eliminated, as laser machining techniques can be used to form holes in workpieces which have already been heat treated as part of the manufacturing process to form the shape of the rail itself.

### SUMMARY

A system and method for forming cut lines or holes in an extended length workpiece, such as a frame rail includes an accurately positionable worktable assembly for supporting the frame rail. The accurately positionable worktable assembly positions successive regions of the extended length workpiece with respect to a laser machining system. Accordingly, the extended length workpiece is first secured to the accurately positionable worktable assembly. Sensors detect the position of the accurately positionable worktable assembly. The worktable assembly with the extended length workpiece firmly attached thereto is moved precisely with respect to the laser machining system to a position on the workpiece where cut lines or holes using laser machining techniques can be made at predetermined locations within successive regions of the extended length workpiece. By use of a multiple axis laser machining system, cut lines or holes can be made in multiple planes in successive regions of the extended length workpiece. In the preferred embodiment, all cuts and holes are made in one region before the workpiece is moved forward to a successive region for further laser machining.

### BRIEF DESCRIPTION OF THE DRAWING FIGURES

A better understanding of the system and method for laser machining of extended length workpieces may be had by reference to the drawing figures, wherein:

FIG. 1 is a side elevational view of a prior art laser machining system;

FIGS. 2A, 2B, and 2C are side elevational views of the system and method of the present invention forming cut lines or holes in successive regions of an extended length workpiece; and

FIG. 3 is a cross-sectional view of the system and method shown in FIG. 2A.

### DETAILED DESCRIPTION OF THE EMBODIMENTS

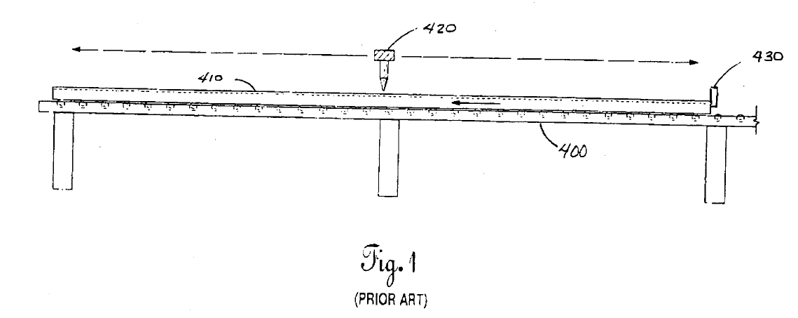

As shown in FIG. 1, the laser machining techniques generally associated with modem manufacturing processes include a table or conveyor 400 which moves a planar workpiece 410 under a one or two axis laser machining system 420. The workpiece 410 generally is moved until it contacts a stop 430. Based on the contact of the planar workpiece 410 with the stop 430, the laser machining system 420 then cuts away sections of the planar workpiece 410 or forms holes therein. When the laser machining operations are complete, the stop 430 is removed and the next planar workpiece is moved under the laser machining system 420.

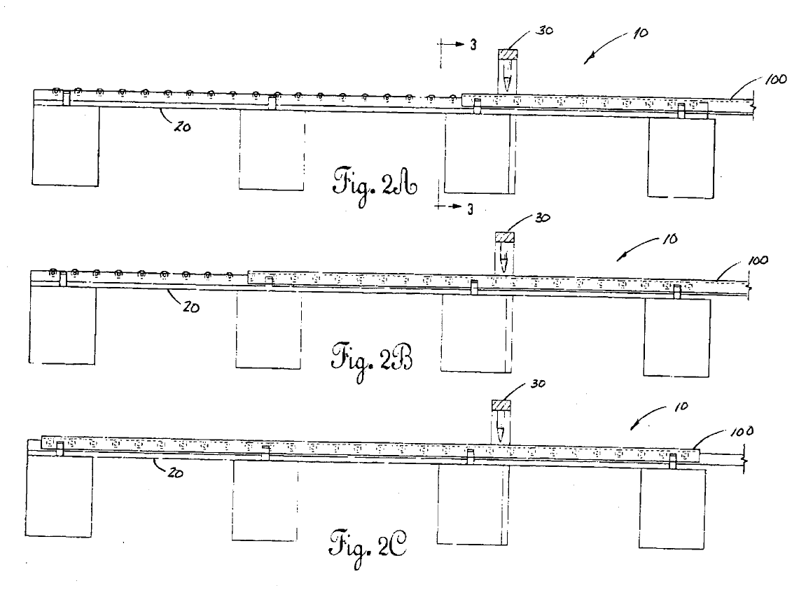

As shown in FIGS. 2A, 2B, and 2C, the system and method of the present invention moves the use of laser machining techniques into manufacturing processes for extended length and multi-planar workpieces 100 such as a channel used to make an extended length frame rail. Heretofore, it was generally felt that extended length workpieces were not candidates for use with laser machining techniques, as needed tolerances for accurate placement of cut lines or holes could not be maintained.

The disclosed system and method 10 combines the technology associated with accurately positionable worktable assemblies or bedways 20 that are typically used with high precision milling machines with a multi-planar laser machining system 30. Accordingly, rather than entirely relying on the accurate positioning provided by the laser machining system which supports and controls the movement of the laser light beam generator 32, accuracy of positioning is provided by the mechanism which moves the worktable assembly or bedway 20.

The utilization of the disclosed system 10 begins by placing the frame rail 100 on the accurately positionable worktable assembly 20. The accurately positionable worktable assembly 20 then moves the extended length workpiece 100 under the laser machining system 20. Because of the extended length of the workpiece 100, the workpiece 100 is moved under the laser machining system 30 in successive regions. The division of the extended length workpiece 100 into successive regions minimizes the amount of movement and control required of the laser light beam generator 32 itself.

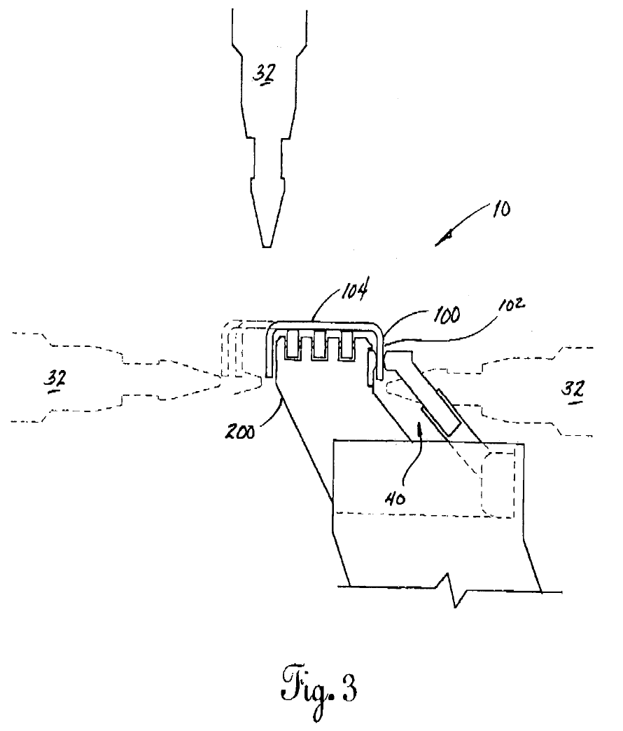

As shown in FIG. 3, by using an accurately positionable worktable assembly or bedway 20 which includes an assembly 40 for securing the workpiece 100 in a known, fixed location, it is possible to use laser machining systems 30 known in the art as five axis systems which include one or more laser light beam generators 32. Such systems will be able to form cut lines or make holes at various positions on an extended length workpiece 100 such as an extended length channel frame rail. Specifically, the laser machining system 30 will be able to make cut lines or form holes in the flange portions 102 or the web portion 104 of the channel 100. In more sophisticated embodiments of the present invention, multiple laser machining systems may be used so that laser machining operations may take place at various locations simultaneously. When all of the cut lines and holes have been formed in the first region of the workpiece 100, the extended length workpiece 100 is then moved to the second region where, once again, the cut lines or holes are formed in predetermined locations. When the second region has been completed, the workpiece 100 is then moved in an accurate manner by the accurately positionable worktable assembly 20 to yet another region. Once again, the laser machining system 30 forms the cut lines or holes at the predetermined locations, and eventually the workpiece 100 is moved out from under the laser machining system 30.

While the present invention has been described according to its preferred and alternate embodiments, those of ordinary skill in the art will understand that still other numerous embodiments have been enabled by the foregoing disclosure. Such other embodiments shall be included within the scope and meaning of the appended claims.

What is claimed is:

1. A system for producing an extended length linear workpiece with accurately positioned cut lines formed in multiple planes thereof, said system comprising:
means for supporting the extending length linear workpiece;
a laser cutting system constructed and arranged to make cuts in multiple planes of the extended length linear workpiece;
means for accurately locating the extended length linear workpiece with respect to said laser cutting system.

2. The system as defined in claim 1 wherein said laser cutting system includes one or more individual laser light beam generating devices.

3. The system as defined in claim 2 wherein the movement of said one or more individual laser light beam generating devices is substantially limited to a region of said extended length linear workpiece in which the accurately positioned cut line is located.

4. The system as defined in claim 1 wherein the location of the accurately positioned cut line is dependent primarily on said means for accurately locating the extended length linear workpiece with respect to said laser cutting system.

5. The system as defined in claim 1 wherein said laser cutting system is used to form holes in the extended length linear workpiece.

6. A system for the laser machining of holes in a frame rail for use in a vehicle, said system comprising:
a laser machining system constructed and arranged to use at least one laser light beam for the cutting of holes in one or more planes of the frame rail;
means for sequentially positioning successive regions of the frame rail with respect to said laser machining system.

7. The system as defined in claim 6 wherein said laser machining system includes at least one laser light beam generator.

8. The system as defined in claim 7 wherein said laser machining system is capable of forming holes in the frame rail in at least two planes.

9. The system as defined in claim 7 wherein the movement of said at least one light beam generator is limited to that region of the frame rail in which the hole is to be formed.

10. The system as defined in claim 6 wherein the accuracy of the location of the holes in the frame rail is determined primarily by said means for accurately positioning the frame rail.

11. A method for increasing the positional accuracy of holes formed by lasers in multiple planes of an extended length substantially linear workpiece, said method comprising the steps of:
placing the extended length substantially linear workpiece on a movable support table;
moving said movable support table to a position with respect to a laser hole cutting system;
forming holes in multiple planes of the extended length substantially linear workpiece with said laser hole cutting system.

12. The method as defined in claim 11 wherein said laser hole cutting system includes one or more individual laser light beam generating systems.

13. The method as defined in claim 12 wherein the movement of said one or more individual laser light beam generating systems is substantially limited to a region of the substantially linear workpiece in which the hole is to be formed.

14. The method as defined in claim 11 wherein the accuracy of the location of the holes formed in the substantially linear workpiece is dependent primarily on said step of moving said movable support table to a position with respect to a laser hole cutting system.

15. A method for machining an extended length workpiece by using at least one laser to make cut lines in at least one plane of said extended length workpiece, said method comprising the steps of:
supporting the extended length workpiece on a movable support table;
moving said movable support table to a predetermined position for positioning the extended multiple length workpiece with respect to the at least one laser;
moving the at least one laser to form cuts in predetermined locations in at least one plane in the extended length workpiece;
whereby the accuracy of the cut line is determined primarily by said movement of said movable support table.
